(19) United States
(12) Patent Application Publication
(10) Pub. No.: US 2005/0195341 A1
(43) Pub. Date: Sep. 8, 2005

(54) Display device

(76) Inventors: Nobuyuki Koganezawa, Chiba (JP); Hiroshi Tokuyama, Mobara (JP); Akiyoshi Tobe, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/068,801

(22) Filed: Mar. 2, 2005

(30) Foreign Application Priority Data
Mar. 2, 2004 (JP) 2004-057614

(51) Int. Cl. G02F 1/1335

(52) U.S. Cl. 349/62

(57) ABSTRACT

A display device includes an optical compensation sheet stacked body mounted on a back surface of a liquid crystal display panel, and a light guide plate mounted on a back surface of the optical compensation sheet stacked body. A first air layer is interposed between the optical compensation sheet stacked body and the light emitting surface of the light guide plate, and a plurality of diffusion plates are mounted on the light incident surface of the light guide plate. A reflection sheet is arranged to face the light guide plate, and an array of an LED chips is provided on a front surface of the reflection sheet. A second air layer is interposed between the light diffusion plates and the LED array. Light from the LED chips having a plurality of colors is mixed and effective optical path length can be prolonged, whereby the least coupling loss is obtained.

### BACKGROUND OF THE INVENTION

The present invention relates in general to a display device; and, more particularly, the invention relates to a solid-light-emitting element (LED) direct backlight unit, which is mounted on a back surface of a liquid crystal display panel and is represented by a light emitting diode which irradiates light to the liquid crystal display panel.

Recently, a liquid crystal display device which is light-weight and exhibits a low power consumption has been popularly used. This liquid crystal display device is constituted of a liquid crystal display panel in which a liquid crystal layer is sandwiched between a pair of insulating substrates, wherein at least one of the insulating substrates is preferably made of glass. The liquid crystal display panel has electrodes for selecting pixels, or active elements, such as thin film transistors, on an inner surface/inner surfaces of one or both insulating substrates thereof, whereby electronic latent images are produced on the selected pixels, and the latent images are visualized by irradiating light on the pixels from a front surface or a back surface of the panel.

Particularly, in a display device, such as a personal computer, a display monitor, a television receiver set or the like, a structure in which a light source is provided on a back surface of the liquid crystal display panel has been popularly used. This back-surface-mounting-type light source is referred to as a back light. As a typical example, there is a known liquid crystal display device in which a so-called sidelight type backlight unit is mounted thereon. In such a liquid crystal display device, a light guide plate, such as an acrylic plate, is arranged on a back surface of the liquid crystal display panel, and light from a light source which is mounted on a side periphery is caused to propagate in the light guide plate and is emitted in a direction toward the liquid crystal display panel. Further, there also is a known liquid crystal display device which is provided with a so-called front light unit, wherein a light source is arranged on a front surface of the liquid crystal display panel.

As a light source for this type of liquid crystal display panel, with respect to a notebook type personal computer or a large-sized television receiver set having a relatively large display screen size, there is a structure in which a light guide plate has a cold cathode fluorescent lamp arranged on a side periphery (side edge) thereof. However, with respect to a mobile phone or miniaturized portable information terminal equipment (a so-called PFA or the like), a solid light emitting element represented by a light emitting diode, for example, which exhibits a low power consumption, has been popularly used in place of the above-mentioned cold cathode fluorescent lamp.

Recently, with respect to a backlight source that uses a light emitting diode which exhibits a high color reproducibility, a quick response and uses no mercury, which is advantageous from viewpoint of preserving a favorable environment, various structures have been proposed as a light source for use in a miniaturized liquid crystal display device. As a result, the use of a light emitting diode as the backlight light source for a notebook type personal computer, a large-sized television receiver set and the like has been studied at various companies.

FIG. 10 is a cross-sectional view which diagrammatically illustrates an example of a miniaturized liquid crystal display device, which has a backlight that uses a light emitting diode (LED) as a light emitting element in a light guide body to illuminate the display device. In the drawing, PNL indicates a liquid crystal display panel. In the liquid crystal display panel PNL, a liquid crystal layer is sandwiched between a first substrate SUB1 and a second substrate SUB2, wherein electrodes for forming pixels, active elements or the like are mounted on one or both of the inner surfaces of the first substrate SUB1 and the second substrate SUB2. The first substrate SUB1, on which the active elements are formed, is referred to as an active matrix substrate. This first substrate SUB1, which uses thin film transistors as the active elements, is also referred to as a TFT substrate.

When color filters are formed on the second substrate SUB2, the second substrate SUB2 is referred to as a color filter substrate. To surfaces of the first substrate SUB1 and the second substrate SUB2, polarizers POL1, POL2 are respectively laminated. Further, BL indicates a backlight, which is constituted of a main light guide plate GLBM, that is formed as an acrylic plate, a sub light guide plate GLBS, a reflection plate REF, which optically connects the main light guide plate GLBM and the sub light guide plate GLBS, a light introducing portion GLB1, which is optically connected to one end of the sub light guide plate GLBS, and a light emitting diode array LEDA, which is optically connected to the light introducing portion GLB1 and has LED chips for emitting light of R(red), G(green), B(blue) colors.

Further, between the liquid crystal display panel PNL and the backlight BL, an optical compensation sheet in the form of a stacked body OPS is interposed. The optical compensation sheet stacked body OPS is formed by stacking a first diffusion sheet DF1, a first prism sheet PRZ1, a second prism sheet PRZ2 and a second diffusion sheet DF2 in this order from the main light guide plate GLBM side of the backlight BL. The direction of the prism grooves of the second prism sheet PRZ2 is arranged to cross the direction of prism grooves of the first prism sheet PRZ1. A light emitting surface of the main light guide plate GLBM, that is, the surface of the main light guide plate GLBM, which faces the optical compensation sheet stacked body OPS, is flat.

In a liquid crystal display device having such a constitution, the light passes through the second prism sheet PRZ2 and the second diffusion sheet DF2 and is incident on the back surface of the liquid crystal display panel PNL substantially vertically. The light which passes through the first prism sheet PRZ1 and the second prism sheet PRZ2 has brightness irregularities, which are attributed to the light passing through the first prism sheet PRZ1 and the second prism sheet PRZ2. This light is rectified by a light diffusion action of the second diffusion sheet DF2 and irradiates the back surface of the liquid crystal display panel PNL.

Here, with respect to miniaturized liquid crystal display device having a backlight device which uses a light emitting diode as the light emitting element in the light guide body, Japanese Patent Laid-open Hei8-304612 (literature 1) can be cited, for example.

### SUMMARY OF THE INVENTION

In a recent large-sized television receiver set, monitor device or the like, the above-mentioned cold cathode fluorescent lamp is used as a light source, wherein the cold cathode fluorescent lamp suppresses the in-plane irregularities of the light source light ([Max−Min]/average) within 20% and the chromaticity distribution irregularities (Max/Min) within approximately 1.05, and this is a level which is not substantially noticeable with respect to a subjective evaluation.

However, in a liquid crystal display device having the above-mentioned constitution, which uses a light emitting diode as the backlight source, the light emitted from the light emitting diode array LEDA can prolong the length of the optical path formed by the light introducing portion GLB1, the sub light guide plate GLBS and the main light guide plate GLBM through which the light sequentially propagates; and, hence, the irregularities of the in-plane brightness and the chromaticity of the light source light projected to the back surface of the liquid crystal display panel PNL can be made relatively small. Thus, it is possible to obtain optically extremely preferable light source light. On the other hand, a coupling loss is generated between respective kinds of optical members which are present between the optical paths, and, hence, only approximately 50 to 60% of the light emitted from the light emitting diode array LEDA is irradiated to the liquid crystal display panel PNL from the surface of the optical compensation sheet stacked body OPS, thus giving rise to a drawback in that the utilization efficiency of the light source light is low.

Accordingly, with respect to a backlight unit which is applicable for use in a large-sized television receiver set, a monitor device and the like, which are required to exhibit high brightness, the application of a direct backlight unit which has a small coupling loss becomes a requisite. With respect to the direct backlight unit, an attempt to ensure that there will be a prolonged optical path by using the usual means to enhance the degree of color mixing increases the thickness of the whole backlight unit, and, hence, the use of a direct backlight is not practical. On the other hand, when using a structure in which the thickness of the backlight unit is reduced, the irregularities of the in-plane brightness and the chromaticity distribution are increased. Accordingly, there has been a drawback in that the direct backlight unit cannot produce a subjective evaluation equal to or superior to the subjective evaluation given to the current backlight unit which uses a cold cathode fluorescent lamp.

The present invention has been made to overcome the above-mentioned problems, and it is an object of the present invention to provide a display device having an LED direct backlight unit which can produce the equivalent or a superior brightness, color chromaticity and the like compared to a current backlight unit which uses a cold cathode fluorescent lamp.

To achieve the above-mentioned object, a display device according to the present invention includes a liquid crystal display panel in which a liquid crystal layer is sandwiched between a pair of transparent substrates which have electrodes for forming pixels formed on inner surfaces thereof; an optical compensation sheet stacked body, which is mounted on a back surface of the liquid crystal display panel; a light guide plate, which is mounted on a back surface of the optical compensation sheet stacked body and includes a light emitting surface which emits light by developing the light in a planar shape relative to a front surface, which faces the liquid crystal display panel in an opposed manner and includes a light incident surface which allows the light to be incident on a back surface which faces the light emitting surface in an opposed manner; a first air layer which is interposed between the optical compensation sheet stacked body and the light emitting surface of the light guide plate; a plurality of diffusion plates which are mounted on the light incident surface of the light guide plate; a reflection sheet which is arranged to face the light incident surface of the light guide plate in an opposed manner; an LED array in which an LED chip is arranged on a front surface of the reflection sheet; and a second air layer, which is interposed between the plurality of light diffusion plates and the LED array, whereby it is possible to improve the brightness distribution and the chromaticity distribution, while suppressing the lowering of the brightness, thus overcoming the drawbacks of the related art.

Here, the LED array may be configured by arranging LED chips capable of emitting a plurality of colors on portions corresponding to positions where a plurality of light diffusion plates are formed.

Further, it is preferable that, in the above-mentioned constitution, assuming that the distance from an arrangement surface of the plurality of LED chips to the back surface of the optical compensation sheet stacked body is 1, by mounting the plurality of light diffusion plates at a position closer than 0.3 from the arrangement surface of the plurality of LED chips, it is possible to improve the brightness distribution and the chromaticity distribution, while suppressing the lowering of the brightness, thus overcoming the drawbacks of the related art.

Further, it is still preferable that, in the above-mentioned constitution, by forming a plurality of light diffusion plates in a disc shape, it is possible to further improve the brightness distribution and the chromaticity distribution, while suppressing the lowering of the brightness, thus overcoming the drawbacks of the related art.

Further, it is still preferable that, in the above-mentioned constitution, by holding the plurality of light diffusion plates on a back surface of the light guide plate, it is possible to further improve the brightness distribution and the chromaticity distribution, while suppressing the lowering of the brightness, thus overcoming the drawbacks of the related art.

Further, another display device according to the present invention includes a liquid crystal display panel in which a liquid crystal layer is sandwiched between a pair of transparent substrates, which have electrodes for forming pixels on the inner surfaces thereof; an optical compensation sheet stacked body, which is mounted on a back surface of the liquid crystal display panel; a light guide plate, which is mounted on a back surface of the optical compensation sheet stacked body and includes a light emitting surface which emits light by developing the light in a planar shape relative to a front surface which faces the liquid crystal display panel in an opposed manner, as well as a light incident surface which allows the light to be incident on a back surface which faces the light emitting surface in an opposed manner; a first air layer, which is interposed between the optical compensation sheet stacked body and the light emitting surface of the light guide plate; a diffusion sheet, which is mounted on the light emitting surface of the light guide plate; a reflection sheet, which is arranged to face the light incident surface of the light guide plate in an opposed manner; an LED array which has LED chips of a plurality of colors mounted on a front surface of the reflection sheet; and a second air layer, which is interposed between the light incident surface of the light guide plate and the LED array, whereby it is possible to improve the brightness distribution and the chromaticity distribution, while suppressing the lowering of the brightness thus overcoming the drawbacks of the related art.

Further, it is preferable that, in the above-mentioned constitution, assuming that the distance from an arrangement surface of the LED chip to the back surface of the optical compensation sheet stacked body is 1, by mounting the light diffusion sheet at a position which falls within a range of 0.38 to 0.78 from the arrangement surface of the LED chip, using the arrangement position of the LED chip as the reference, it is possible to improve the brightness distribution and the chromaticity distribution, while suppressing the lowering of the brightness, thus overcoming the drawbacks of the related art.

Further, it is still preferable that, in the above-mentioned constitution, by holding the diffusion sheet on the light emitting surface of the light guide plate, it is possible to further improve the brightness distribution and the chromaticity distribution, while suppressing the lowering of the brightness, thus overcoming the drawbacks of the related art.

Further, it is preferable that, in the above-mentioned constitution, assuming that the distance from an arrangement surface of the plurality of LED chips to the back surface of the optical compensation sheet stacked body is 1, by mounting the light diffusion sheet at a position which falls within a range of 0.38 to 0.78 using the arrangement position of the plurality of LED chips as a reference, it is possible to improve the brightness distribution and the chromaticity distribution, while suppressing the lowering of the brightness, thus overcoming the drawbacks of the related art.

Further, it is still preferable that, in the above-mentioned constitution, by holding the diffusion sheet on the light emitting surface of the light guide plate, it is possible to further improve the brightness distribution and the chromaticity distribution, while suppressing the lowering of the brightness, thus overcoming the drawbacks of the related art.

The present invention is not limited to the above-mentioned constitutions and various modifications can be made without departing from the technical concept of the present invention.

According to the present invention, it is possible to elongate the effective optical length by reducing the thickness of the direct backlight unit, and, hence, it is possible to largely enhance the in-plane brightness and the chromaticity distribution, thus exhibiting a high color reproducibility. Further, it is also possible to obtain excellent advantageous effects, such as a high brightness display with a rapid response speed.

Further, according to the present invention, it is possible to obtain an extremely excellent advantageous effect, such as an equivalent or superior in-plane brightness, and an enhanced chromaticity distribution, compared to the cold cathode fluorescent lamp which uses mercury, and the use of the mercury-free direct backlight unit for a large-sized display device is friendly to the environment.

### BRIEF DESCRIPTION OF THE SEVERAL VIEWS OF THE DRAWING

FIG. 1 is a diagram which illustrates the constitution of an embodiment 1 of a liquid crystal display device having a direct LED backlight unit as the illumination source of a display device according to the present invention;

FIG. 2 is an enlarged plan view showing the planar structure of the liquid crystal display device shown in FIG. 1 as viewed from the A-A′ line direction;

FIG. 3 is an enlarged cross-sectional view showing the positional relationship between a disc-like light diffusion plate and an LED chip;

FIG. 4(a) is a side view and FIG. 4(b) is a developed perspective view illustrating the constitution of the liquid crystal display device shown in FIG. 1;

FIG. 5 is a graph showing the relationship of evaluation functions among the brightness, the brightness distribution and the chromaticity distribution with respect to the position of the disc-like diffusion plate;

FIG. 6(a) is a side view and FIG. 6(b) is a developed perspective view illustrating the constitution of an embodiment 2 of a liquid crystal display device having a direct LED backlight unit as the illumination source of a display device according to the present invention;

FIG. 7 is a graph showing the relationship of evaluation functions among the brightness, the brightness distribution and the chromaticity distribution with respect to the position of a planar diffusion sheet;

FIG. 8 is a developed perspective view showing one example of the overall constitution of the display device according to the present invention;

FIG. 9 is a diagram showing a front view of a television receiving set which constitutes one example of electronic equipment in which a liquid crystal display module is provided as a liquid crystal display device according to the present invention; and

FIG. 10 is a cross-sectional view showing an example of a miniaturized liquid crystal display device having a backlight unit using a light emitting diode (LED) as a light emitting element.

### DETAILED DESCRIPTION OF THE INVENTION

Hereinafter, specific embodiments of the present invention will be explained in detail in conjunction with the drawings. In the drawings, parts having identical functions are indicated by same reference symbols, and a repeated explanation thereof is omitted.

### Embodiment 1

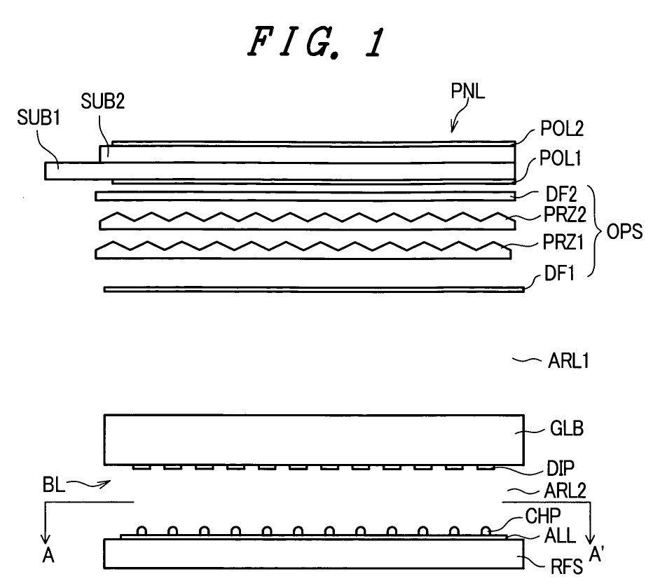

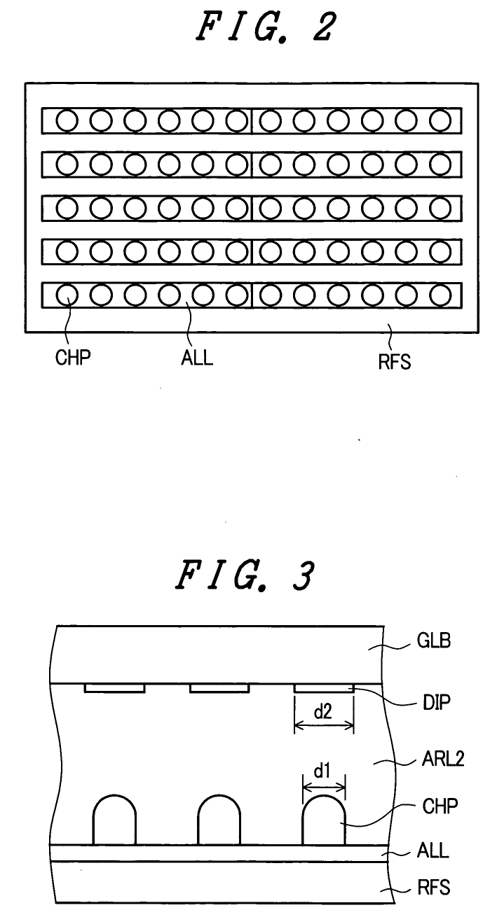

FIG. 1 and FIG. 2 show the constitution of an embodiment 1 of a liquid crystal display device having a direct LED backlight unit. In FIG. 1, reference designation PNL indicates a liquid crystal display panel. In this liquid crystal display panel PNL, a liquid crystal layer LC is sandwiched between a first substrate SUB1 and a second substrate SUB2, formed of a glass plate and having pixels formed on inner surfaces thereof. A first polarizer POLL is laminated to a first main surface (backlight device side) and a second polarizer POL2 is laminated to a second main surface (display surface side) by adhesion.

Further, on a back surface side of the liquid crystal display panel PNL, an optical compensation stacked sheet OPS is arranged. On a back surface side of the optical compensation stacked sheet OPS, a light guide plate GLB, formed of a transparent acrylic resin material, is arranged by way of a first air layer ARL1. On a back surface of the light guide plate GLB, a plurality of disc-like light diffusion plates DIP are held and arranged by adhesion or the like.

Further, on the back-surface side of the light guide plate GLB, a reflection sheet RFS, made of a white PET (polyethrene-terephthalate resin) material, is arranged by way of a second air layer ARL2. On a front surface of the reflection sheet RFS, which faces the light guide plate GLB, plural sets of LED arrays ALL, which are formed by orderly arranging LED chips CHP, which produce red light emission, green light emission and blue light emission, are held and arranged by adhesion or the like. The reflection sheet RFS, formed of the white PET material, has a function of enhancing the color reproducibility. That is, the reflection sheet RFS scatters the red light, the green light and the blue light emitted from the respective LED chips and, at the same time, mixes these lights and reflects the mixed light toward the back surface direction of the light guide plate GLB.

Further, the respective disc-like light diffusion plates DIP, which are arranged on the back surface of the light guide plate GLB, and the respective LED chips CHP, which constitute the LED array ALL, face each other in an opposed manner, as shown in FIG. 3, and they are respectively arranged on the same straight line. Assuming that the diameter of each LED chip CHP is “d₁” and a diameter of each light diffusion plate is “d₂”, the LED chips CHP and the light diffusion plates DIP are formed while having the relationship d₂>d₁. Accordingly, the light emitted from the LED chip CHP directly impinges on a surface of the disc-like light diffusion plate DIP and is reflected and scattered in the inside of the second air layer ARL2, thus making the direct incidence and transmission of light in the inside of the light guide plate GLB difficult. That is, the LED chips CHP and the light diffusion plates DIP have a function of improving the brightness distribution and the chromaticity distribution.

Further, the plurality of disc-like light diffusion plates DIP are respectively arranged at positions which correspond to the positions where the respective LED chips CHP on the LED arrayALL are arranged, such that the light diffusion plates DIP block the direct light from the respective LED chips CHP.

The disc-like light diffusion plates DIP prevent the light emitted from the LED chips CHP from directly passing through the light guide plate GLP and directly advancing to the back surface (illumination surface) of the liquid crystal display panel PNL, thus preventing a deterioration of the brightness distribution and the chromaticity distribution attributed to a phenomenon in which the positions of the light sources, such as the LED chips CHP, directly appear on the illumination surface. Further, the disc-like light diffusion plates DIP have a light diffusing property as well as a light reflection property simultaneously.

Further, the plurality of disc-like light diffusion plates DIP, which are arranged on the back surface of the light guide plate GLB, may be formed as follows. For example, the back surface of the light guide plate GLB is formed in a planar shape. Thereafter, a plurality of disc-like metal thin films having a light diffusion property are laminated to the back surface of the light guide plate GLB in the form of a film and are held by adhesion or the like. Further, at the time of forming a compact body made of acrylic resin, given portions may be formed in a projecting shape by an integral molding method, and metal plating may be applied to distal end portions thereof. Further, in place of these disc-like light diffusion plates DIP, metal seals having a light diffusion property or metal seals having a light reflection property may be used.

As shown in FIG. 1, the above-mentioned optical compensation stacked sheet OPS is formed by stacking a first diffusion sheet DF1, a first prism sheet PRZ1, a second prism sheet PRZ2 and a second diffusion sheet DF2 in this order from the side of the backlight BL, which faces the light guide plate GLB in an opposed manner. The direction of the prism grooves of the second prism sheet PRZ2 is arranged to cross the direction of the prism grooves of the first prism sheet PRZ1. The light emitting surface of the main light guide plate GLBM, that is, the surface of the main light guide plate GLBM which faces the optical compensation sheet stacked body OPS, is made flat. Further, it is also possible to apply the diffusion treatment to one surface or to both surfaces of the first prism sheet PRZ1.

Further, the first diffusion sheet DF1 and the second diffusion sheet DF2, which are arranged on the back surface of the optical compensation stacked sheet OPS, have an auxiliary function of efficiently enhancing the center brightness of the optical compensation stacked sheet OPS by squeezing the angle of the emitted light which is diffused from the light emitting surface of the light guide plate GLB. With the provision of such an auxiliary function, the optical compensation stacked sheet OPS can reduce the occurrence of brightness irregularities and chromaticity irregularities as a whole.

Further, with respect to the above-mentioned optical compensation stacked sheet OPS, the first air layer ARL1, the light guide plate GLB, the second air layer ARL2, the LED array ALL, the reflection sheet RFS and the like, although reflection members formed of a PET material or the like are laminated to side peripheral portions thereof, illustration of the reflection members is omitted from the drawing. The above-mentioned various constitutional members are housed in the inside of a box-like mold case (not shown in the drawing) in a state such that the constitutional members are arranged at given positions at a given interval, thus constituting the direct LED backlight unit BL.

The inventors of the present invention have, while changing the mounting position of the LED chips CHP, the mounting position of the disc-like light diffusion plates DIP and the mounting position of the planar first diffusion sheet DF1, respectively, extensively studied the changes that occurred in the brightness, the brightness distribution, the chromaticity distribution and the like, and they have found that a backlight unit which is optimum for a liquid crystal display device can be obtained by defining the positional relationship of these constitutional members.

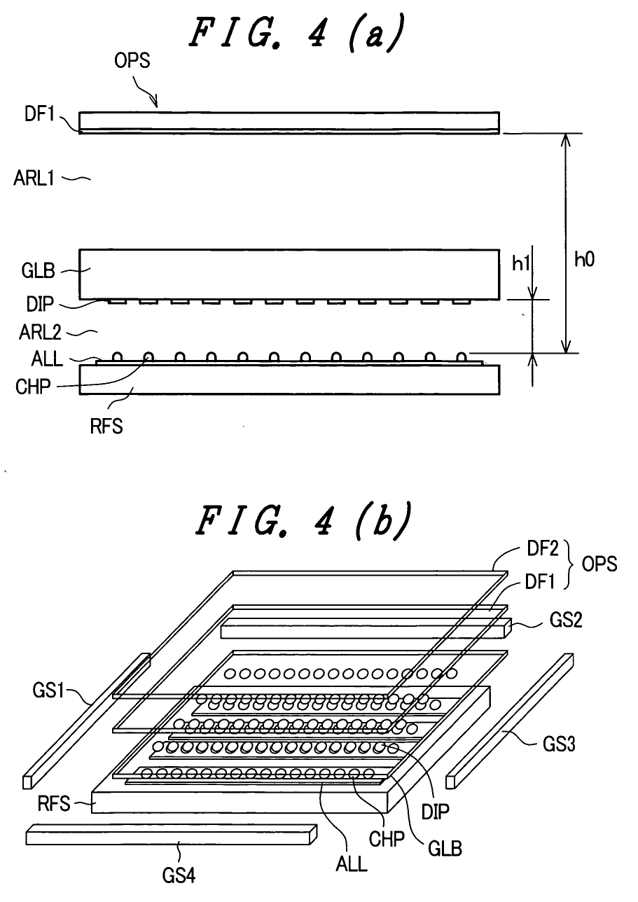

In FIG. 4(a), assuming that the distance from the installation surface of the LED chip CHP to the disc-like light diffusion plate DIP is “h1”, the distance from the installation surface of the LED chip CHP to the back surface of the first diffusion sheet DF1 on the back surface side of the optical compensation sheet stacked body OPS is measured to determine “h0”, thus finding out the optimum value of the backlight unit BL. Here, the plurality of disc-like light diffusion plates DIP arranged on the back surface of the light guide plate GLB are mounted to correspond to the arrangement and positions of the respective LED chips CHP on the respective LED arrays ALL, as shown in FIG. 4(b). Further, in FIG. 4B, GS1, GS2, GS3, GS4 indicate shape elastic members which hold the various constitutional members at given positions.

To be more specific, as shown in FIG. 4(a), within a range of the LED chip CHP to the optical compensation sheet stacked body OPS, by fixing the distance h0 from the surface of the LED chip CHP to the diffusion sheet DF1 and by changing the distance h1 from the surface of the LED chip CHP to the disc-like light diffusion plate DIP, the measurements of the brightness, brightness distribution and the chromaticity distribution are performed.

Here, measurement is performed by using the optical measurement equipment BM-7 manufactured by Topcon Ltd. under measurement conditions in which the ambient temperature is set to a room temperature of approximately 25° C. and the distance to the light surface measurement point of the measurement equipment lens is set to 500 mm. Here, 500 mm indicates the shortest focal length of the BM-7.

In accordance with the present invention, as references to evaluate the brightness, the brightness distribution and the chromaticity distribution, evaluation indexes are used. The evaluation indexes are relative indexes of the brightness, the brightness distribution and the chromaticity distribution with respect to a target value of 100. It is assumed that, as these evaluation indexes become larger, the brightness, the brightness distribution and the chromaticity distribution will be improved. Further, according to the present invention, using the present company's standard as a reference, evaluation indexes approximately equal to or more than 80% are desired.

Further, with respect to the position “a” of the disc-like light diffusion plate DIP, assuming that the distance “h0” from the LED chip CHP, which constitutes a light source, to the first diffusion sheet DF1 on the back surface side of the optical compensation sheet stacked body OPS is “1” and the distance from the surface of the LED chip CHP to the disc-like light diffusion plate DIP is “h1”, the position “a” indicates the relative position in the LED backlight unit BL as the position which is expressed by the relationship a=h1/h0.

Here, the target brightness of the LED backlight unit BL at this point of time is approximately 8000 cd/m². The reason why the target brightness at this point of time is concerned is that, with the use of the TFT liquid crystal display panel transmissivity and brightness enhancing film, the brightness is expected to be enhanced from approximately 7000 cd/m², which is the target value of a liquid crystal display device on which a liquid crystal display panel is mounted.

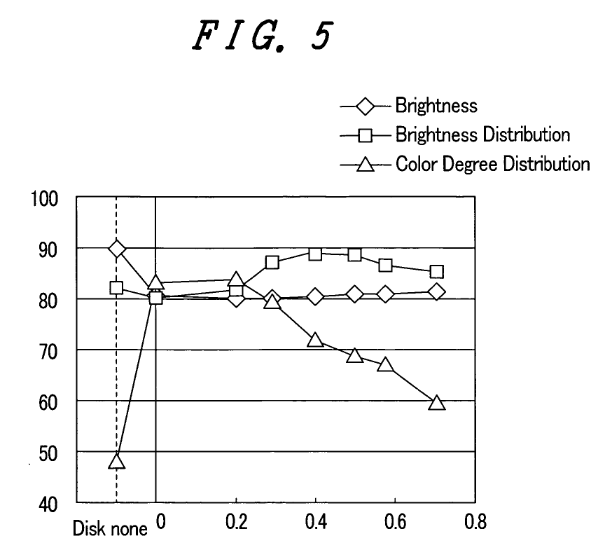

Next, the measurement results will be explained in detail in conjunction with a following Table 1 and FIG. 5. FIG. 5 shows the relationship in which the position “a” of the disc-like light diffusion plate DIP is taken along an axis of abscissas and the evaluation index of the brightness, the brightness distribution and the chromaticity distribution are taken along an axis of ordinates. First of all, it is understood that, when the disc-like light diffusion plate DIP is not mounted on the back surface of the light guide plate GLB, although the brightness and the brightness distribution will exceed the evaluation index 80 similar to the case in which the disc-like light diffusion plate DIP is mounted, the pigment irregularities are remarkable and the chromaticity distribution is below the evaluation index 80.

TABLE 1
position “a” of disc-like diffusion plate

| | | | | | | | |
|---|---|---|---|---|---|---|---|
| none | 0 | 0.2 | 0.287 | 0.4 | 0.5 | 0.575 | 0.7 |

Next, it is found that, as a result of various measurements performed by varying the position “a” of the disc-like light diffusion plate DIP in the range of 0 to 0.8, the brightness is substantially constant and hardly changes from the vicinity of the evaluation index 80 at all positions. Further, it is found that, with respect to the chromaticity distribution, the evaluation index begins to fall when the relative position of the disc-like light diffusion plate DIP is 0.2 and the evaluation index becomes 80 when the relative position is 0.3, and, further, when the relative position exceeds 0.4, the evaluation index becomes lower than 70. Further, it is found that, with respect to the brightness distribution, the evaluation index is higher than 80 at the whole range, and, particularly, the evaluation index is extremely favorable when the relative position is in the range of 0.2 to 0.7, and, further, when the relative position is 0.5, the evaluation index begins to fall.

Here, assuming that the allowable evaluation index is equal to or more than 80, although the brightness and the brightness distribution are allowable at all positions, with respect to the chromaticity distribution, the evaluation index becomes lower than 80 when the relative position of the disc-like light diffusion plate DIP is equal to or more than 0.3, and, hence, it is understood that the range of the favorable relative position “a” is 0<a<0.3. This result represents an optimum value of the relationship between the thickness of the air layer ARL2 between the LED array ALL and the disc-like light diffusion plate DIP and the thickness of the air layer ARL1 between the light guide plate GLB and the diffusion sheet DF1. Further, it is understood that when the relative position “a” is in the range of 0<a<0.2, an even more favorable display property is exhibited.

### Embodiment 2

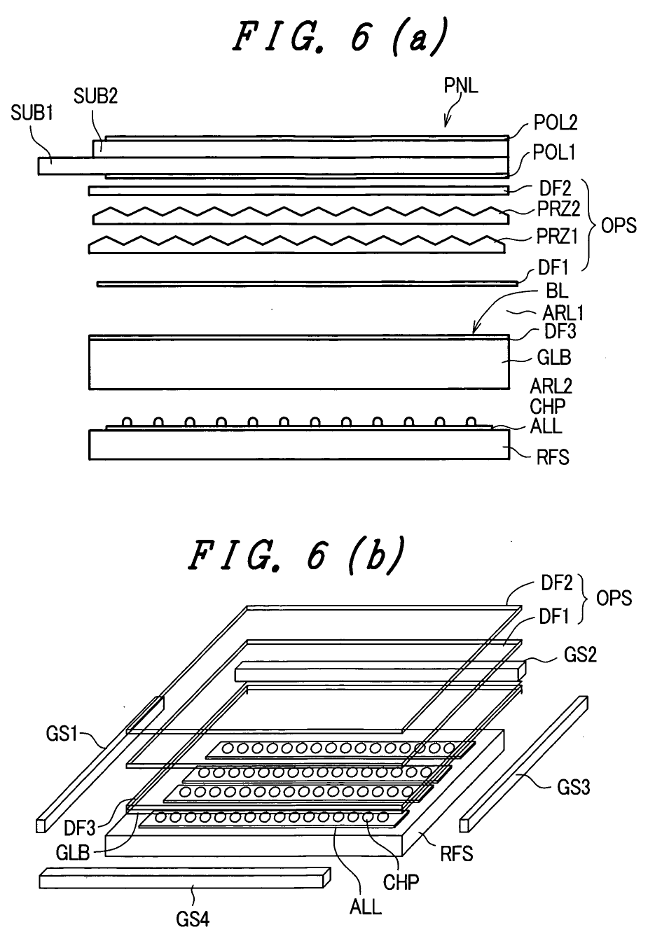

FIG. 6(a) and FIG. 6(b) show an embodiment 2 of the liquid crystal display device which is provided with a back direct type LED backlight unit according to the present invention. In the drawing, parts having identical functions with parts in FIG. 1 are given the same symbols, and a repeated explanation thereof will be omitted. The constitution of FIG. 6(a) and FIG. 6(b) differs from the constitution of FIG. 1 in that the disc-like light diffusion plate DIP of embodiment 1 is not mounted on the light incident surface of the light guide plate GLB; and, on the portion of the light incident surface which faces to the optical compensation sheet stacked body OPS, a planar light diffusion sheet DF3 is fixed by adhesion or the like.

In such a constitution, by changing the position of the planar light diffusion sheet DF3 mounted on the light incident surface of the light guide plate GLB, focusing on the changes of the brightness, the brightness distribution and the chromaticity distribution, a measurement similar to the above-mentioned measurement was performed. Here, the reason why the planar light diffusion sheet DF3 is mounted in this embodiment is to study the possibility of improving the brightness, the brightness distribution and the chromaticity distribution, while suppressing a lowering of the brightness which occurs when using the disc-like light diffusion plate DIP of the above-mentioned embodiment 1.

As shown in FIG. 6(a), with respect to the position b of the planar light diffusion sheet DF3, assuming that the distance h0 from the surface of the LED chip CHP to the diffusion sheet DF1 on the back surface side of the optical compensation sheet stacked body OPS is “1” and the distance from the surface of the LED chip CHP to the disc-like light diffusion plate DIP is “h1”, the position “b” indicates the relative position in the LED backlight unit BL as the position which is expressed by the relationship b=h1/h0.

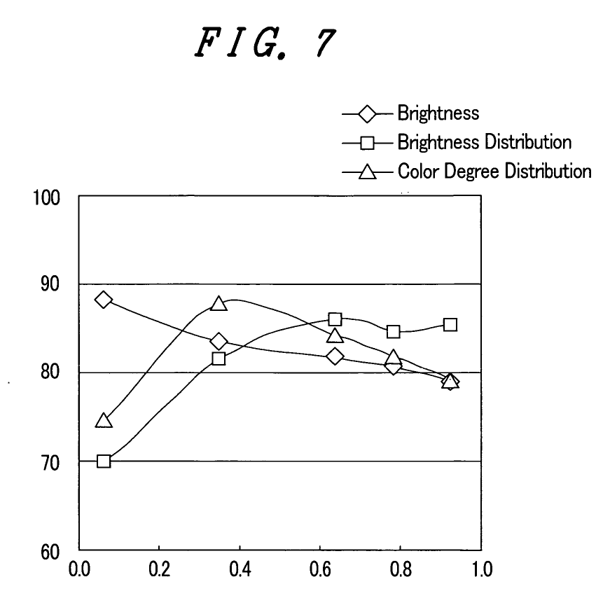

Further, in this embodiment also, an evaluation index of equal to or more than 80 is desired. In the same manner as mentioned above, while changing the position “b” of the planar light diffusion sheet DF3 in the range of 0 to 0.92, various cases were measured in the same manner as mentioned above, and, accordingly, the data shown in the following table 2 and FIG. 7 was obtained. Here, the axis of abscissas indicates the position b of the diffusion sheet and the axis of ordinates indicates the evaluation index. As clearly understood from Table 2 and FIG. 7, when the relative position of the planar light diffusion sheet DF3 is raised, the brightness continues to decrease, and, when the relative position b exceeds 0.8, the brightness becomes lower than the desired evaluation index 80. On the other hand, as the relative position is raised, the brightness distribution is improved, and, when the relative position b=0.34, the brightness distribution exceeds the evaluation index 80, and, even when the relative position is further changed, there is a tendency for the evaluation to rise.

TABLE 2
position “b” of planar light diffusion sheet DF3

| | | | | | | | |
|---|---|---|---|---|---|---|---|
| none | 0.13 | 0.2 | 0.3 | 0.36 | 0.5 | 0.6 | 0.7 |

Further, moving away from the vicinity of b=0, the chromaticity distribution increases, and, when the position b is approximately 0.34, the chromaticity distribution exceeds the evaluation index. Further, in the vicinity of the relative position b=0.4, the chromaticity distribution begins to decrease, and, hence, it is understood that it is favorable to set the mounting position “b” of the planar light diffusion sheet DF3 in the range of 0.38<b<0.78.

Here, it is understood from the data shown in FIG. 7 that when the relative position “b” is in the range of 0.3<b<0.85, the chromaticity distribution exceeds the evaluation index 80. This result also represents an optimum value of the relationship between the thickness of the air layer ARL2 between the LED array ALL and the planar light diffusion sheet DF3 and the thickness of the air layer ARL1 between the light diffusion sheet DF3 and the diffusion sheet DF2.

FIG. 8 is a developed perspective view showing an example of the display device according to the present invention. In FIG. 8, the liquid crystal display panel PNL has drive circuits mounted on the periphery (here, upper side and left side) of the liquid crystal display cell and is provided with a printed circuit board PCB which supplies signals to these drive circuits. Further, on the front and back surfaces of this liquid crystal display cell, polarizers POL1, POL2 are stacked, respectively. The backlight unit BL mounted on the back surface of this liquid crystal display panel PNL includes a mold frame MDL, which stores the light guide plate GLB, the LED array, the diffusion sheet or the like so that they are supported by this mold frame MDL. Further, above the light guide plate, the optical compensation sheet stacked body OPS, including the two sets of prism sheets and diffusion sheets, is mounted.

In this example, as in the embodiment explained with reference to the previously-mentioned FIG. 4 or FIG. 6(a) and FIG. 6(b), in the inner peripheral portion of the mold frame MDL of the backlight unit BL, a shape elastic member is mounted. By way of the shape elastic member GS, the liquid crystal display panel PNL is mounted, and an upper frame SHD is overlaid from above the liquid crystal display panel PNL and connected to a lower frame MFL, thus forming an integrated assembly.

In the liquid crystal display device constituted in this manner, the liquid crystal display panel PNL is irradiated by the light from the backlight unit BL, which is constituted of the light guide plate GLB, the LED array ALL and the reflection sheet RFS, as explained with reference to the embodiment 1 and the embodiment 2, and an electronic latent image formed in the liquid crystal display device PNL is made visible.

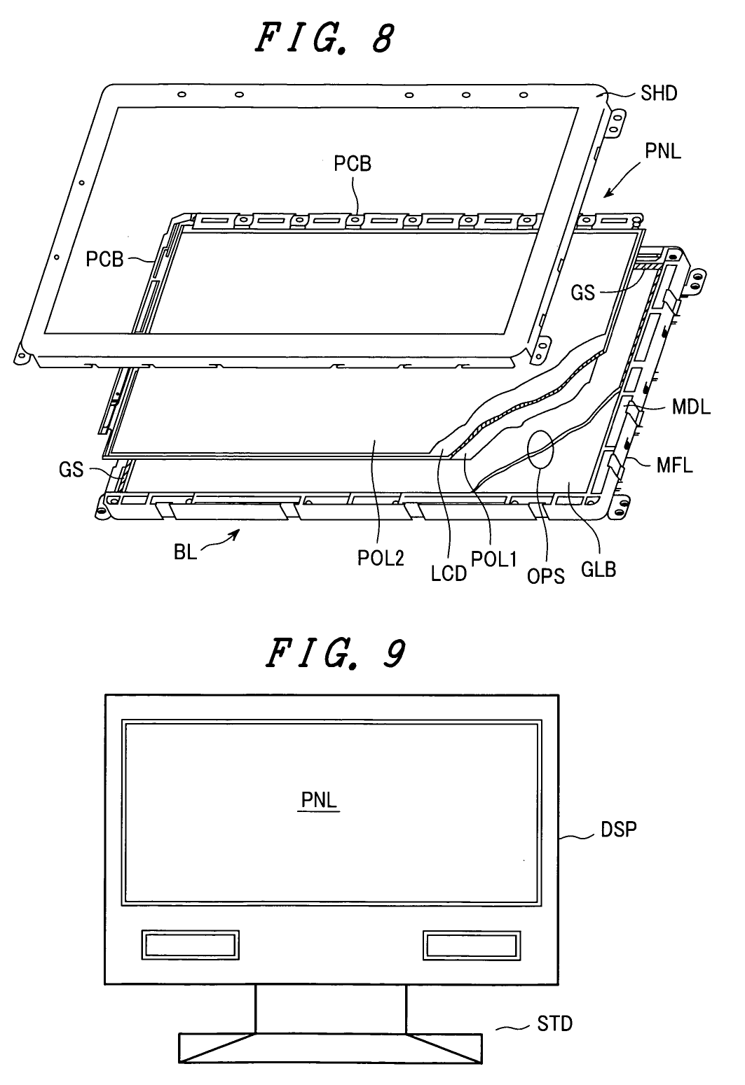

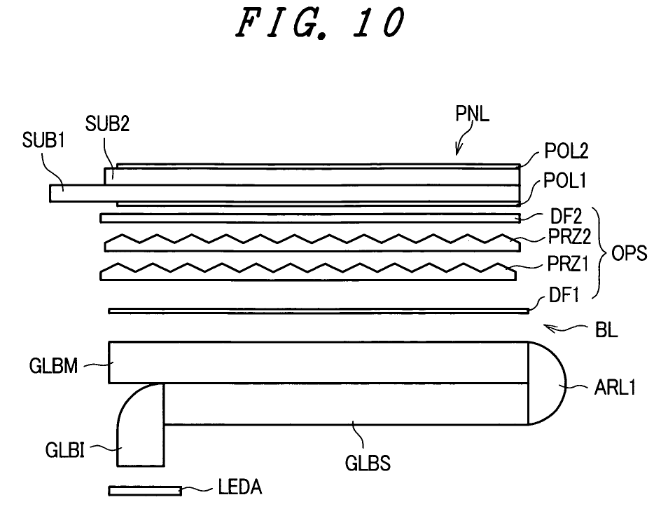

FIG. 9 shows a television receiver set as one example of an electric device on which the liquid crystal display module is mounted as a display device according to the present invention. In FIG. 9, this television receiver set is constituted of the display part DSP and the stand portion STD, and a liquid crystal display device, which is provided with the liquid crystal display panel PNL having a comparatively large size screen, is mounted on the display part DSP. The effective display region of the liquid crystal display panel PNL constituting the screen of the liquid crystal display device is exposed in the display part DSP. By mounting the liquid crystal display device according to the present invention on the display part DSP of this television receiver set, an image display device which exhibits a high color reproductively and has a high quality and the high reliability can be realized.

Further, in the above-mentioned embodiment, a case has been considered in which a liquid crystal module using a liquid crystal display device having a LED backlight unit is applied to a liquid crystal television receiver set. However, even when the present invention is applied to a display device, such as a liquid crystal car navigation display device, a monitor for digital media, a medical liquid crystal monitor, and a print/design liquid crystal monitor, the same advantageous effects as mentioned above can be obtained.

1. A display device comprising:
a liquid crystal display panel which is configured to sandwich a liquid crystal layer between a pair of transparent substrates which have electrodes for forming pixels on inner surfaces thereof;
an optical compensation sheet stacked body which is mounted on a back surface of the liquid crystal display panel;
a light guide plate which is mounted on a back surface of the optical compensation sheet stacked body, includes a light emitting surface which emits light by developing the light in a planar shape to a front surface which faces the liquid crystal display panel in an opposed manner, and includes a light incident surface which allows the light to be incident on a back surface which faces the light emitting surface in an opposed manner;
a first air layer which is interposed between the optical compensation sheet stacked body and the light emitting surface of the light guide plate;
a plurality of diffusion plates which are mounted on the light incident surface of the light guide plate;
a reflection sheet which is arranged to face the light incident surface of the light guide plate in an opposed manner;
an LED array which arranges an LED chip on a front surface of the reflection sheet; and
a second air layer which is interposed between the plurality of light diffusion plates and the LED array.

2. A display device according to claim 1, wherein the LED array is configured by arranging LED chips of a plurality of colors to portions corresponding to positions where a plurality of light diffusion plates are formed.

3. A display device according to claim 1, wherein assuming a distance from an arrangement surface of the plurality of LED chips to the back surface of the optical compensation sheet stacked body as 1, the plurality of the light diffusion plates are mounted at a position smaller than 0.3 from the arrangement surface of the plurality of LED chips.

4. A display device according to claim 2, wherein assuming a distance from an arrangement surface of the plurality of LED chips to the back surface of the optical compensation sheet stacked body as 1, the plurality of the light diffusion plates are mounted at a position smaller than 0.3 from the arrangement surface of the plurality of LED chips.

5. A display device according to claim 1, wherein the plurality of light diffusion plates are formed in a disc shape.

6. A display device according to claim 2, wherein the plurality of light diffusion plates are formed in a disc shape.

7. A display device according to claim 3, wherein the plurality of light diffusion plates are formed in a disc shape.

8. A display device according to claim 1, wherein the plurality of light diffusion plates are held on a back surface of the light guide plate.

9. A display device comprising:
a liquid crystal display panel which is configured to sandwich a liquid crystal layer between a pair of transparent substrates which have electrodes for forming pixels on inner surfaces thereof;
an optical compensation sheet stacked body which is mounted on a back surface of the liquid crystal display panel;
a light guide plate which is mounted on a back surface of the optical compensation sheet stacked body, includes a light emitting surface which emits light by developing the light in a planar shape to a front surface which faces the liquid crystal display panel in an opposed manner, and includes a light incident surface which allows the light to be incident on a back surface which faces the light emitting surface in an opposed manner;
a first air layer which is interposed between the optical compensation sheet stacked body and the light emitting surface of the light guide plate;
a diffusion sheet which is mounted on the light emitting surface of the light guide plate;
a reflection sheet which is arranged to face the light incident surface of the light guide plate in an opposed manner;
an LED array which arranges LED chips of a plurality of colors mounted on a front surface of the reflection sheet; and
a second air layer which is interposed between the light incident surface of the light guide plate and the LED array.

10. A display device according to claim 9, wherein assuming a distance from an arrangement surface of the LED chip to the back surface of the optical compensation sheet stacked body as 1, the light diffusion sheet is mounted at a position which falls within a range of 0.38 to 0.78 from the arrangement surface of the LED chip using the arrangement position of the LED chip as the reference.

11. A display device according to claim 10, wherein the diffusion sheet is held on the light emitting surface of the light guide plate.
